(19) United States
(12) Patent Application Publication
(10) Pub. No.: US 2014/0347344 A1
(43) Pub. Date: Nov. 27, 2014

(54) DISPLAY DEVICE AND DRIVING METHOD THEREOF

(71) Applicant: Samsung Display Co., Ltd., Yongin-City (KR)

(72) Inventors: Won-Jun LEE, Yongin-City (KR); In-Soo WANG, Yongin-City (KR); Gi-Chang LEE, Yongin-City (KR)

(73) Assignee: Samsung Display Co., Ltd., Yongin-City (KR)

(21) Appl. No.: 14/082,820

(22) Filed: Nov. 18, 2013

(30) Foreign Application Priority Data
May 23, 2013 (KR) 10-2013-0058558

(51) Int. Cl. G09G 3/20

(52) U.S. Cl. CPC G09G 3/2092
USPC 345/213

(57) ABSTRACT

A display device includes gate lines which transmits a plurality of gate signals, data lines which transmits a plurality of data signals, and pixels connected to the gate lines and the data lines; a signal controller which generates image data, a data control signal and a gate control signal based on an input video signal and an input control signal; a timing setter including connection pads connected to a voltage of a first level or a voltage of a second level; and a gate driver which generates timing information based on tuning signals transmitted from the timing setter through the connection pads and generates gate signals using the gate control signal and the timing information, where the gate control signal includes a scan start reference signal, which instructs a scan start, and a clock control reference signal, which controls each pulse width of the gate signal.

This application claims priority to Korean Patent Application No. 10-2013-0058558, filed on May 23, 2013, and all the benefits accruing therefrom under 35 U.S.C. §119, the content of which in its entirety is herein incorporated by reference.

### BACKGROUND

(a) Field

Exemplary embodiments of the invention relate to a display device and a driving method of the display device. More particularly, the invention relates to a display device including a gate driver.

(b) Description of the Related Art

In general, a display includes a liquid crystal display (“LCD”), an organic light emitting diode (“OLED”) display, an electrophoretic display, etc. The display device also includes a gate driving integrated circuit (“IC”) and a data driving IC.

The gate driving IC may be integrated at a thin film transistor array panel with an amorphous silicon gate (“ASG”) shape. The gate driving IC typically includes a plurality of shift registers, and each shift register applies a gate signal to a pixel through a corresponding gate line. Also, the data driving IC converts image data into a data voltage and applies the data voltage to data lines.

Due to increased demand for a large-sized panel of the display device, a high speed driving technique to realize a high resolution of the large-sized panel and a slim bezel realization technique to increase an effective display area may receive high attention. In the large-sized panel a width of input wires of the gate driving IC may be decreased to realize the display device with a slim bezel, while a plurality of scan start signals and clock control signals are used to control a plurality of shift registers to drive the large-sized panel at a high speed.

### SUMMARY

Accordingly, an exemplary embodiment of the invention provides a display device, in which timing of a gate signal is controlled by a timing setter after attaching a gate driving integrated circuit (“IC”) to a substrate, with a slim bezel and reduced coupling capacitance between wires, and a driving method of the display device.

An exemplary embodiment of a display device according to the invention includes: a display panel including a plurality of gate lines which transmits a plurality of gate signals, a plurality of data lines which transmits a plurality of data signals, and a plurality of pixels connected to the gate lines and the data lines; a signal controller which generates image data, a data control signal and a gate control signal based on an input video signal and an input control signal; a timing setter including a plurality of connection pads connected to a voltage of a first level or a voltage of a second level; and a gate driver which generates timing information based on a plurality of tuning signals transmitted from the timing setter through the connection pads and generates a plurality of gate signals using the gate control signal and the timing information, where the gate control signal includes a scan start reference signal, which instructs a scan start, and a clock control reference signal, which controls each pulse width of the gate signal.

In an exemplary embodiment, the gate driver may convert each of the tuning signals into digital bits corresponding to the voltage of the first level or the voltage of the second level to generate the timing information, and the gate driver may include an address pointing register which generates a delay time corresponding to the timing information as timing data.

In an exemplary embodiment, the address pointing register may include a lookup table which stores the delay time corresponding to the timing information.

In an exemplary embodiment, the gate lines may be divided in a plurality of groups, and the gate driver may control the groups of the gate lines independently of each other based on the scan start reference signal and the clock control reference signal.

In an exemplary embodiment, the gate driver may include a timing controller which delays the scan start reference signal and the clock control reference signal based on the delay time corresponding to the timing information to generate a plurality of scan start signals corresponding to the groups of the gate lines and a plurality of clock control signals corresponding to the groups of the gate lines.

In an exemplary embodiment, the timing controller may include: a first sub-timing controller corresponding to a first group of the groups of the gate lines and which delays the scan start reference signal and the clock control reference signal by the delay time to generate a first scan start signal of the scan start signals and a first clock control signal of the clock control signals; and a second sub-timing controller corresponding to a second group of the groups of the gate lines and which delays the scan start reference signal and the clock control reference signal by a multiple of the delay time to generate a second scan start signal of the scan start signals and a second clock control signal of the clock control signals.

In an exemplary embodiment, pulse widths of the first scan start signal, the second scan start signal, the first clock control signal and the second clock control signal may be substantially the same as each other.

In an exemplary embodiment, the timing controller may include a sub-timing controller which delays the scan start reference signal by the delay time to generate a first scan start signal of the scan start signals, delays the clock control reference signal by the delay time to generate a first clock control signal of the clock control signals, which corresponds to a first group of the groups of the gate lines, and delays the clock control reference signal by the multiple of the delay time to generate a second clock control signal of the clock control signals, which corresponds to a second group of the groups of the gate lines.

In an exemplary embodiment, the sub-timing controller may generate the scan start signal with a pulse width overlapping rising edges of the first clock control signal and the second clock control signal.

In an exemplary embodiment, the gate driver may include: a plurality of shift registers corresponding to the groups of the gate lines, respectively, and which generates a plurality of pulse signals in synchronization with a rising edge of a corresponding clock control signal of the clock control signals during an activation period of a corresponding scan start signal of the scan start signals; a plurality of level shifters which convert voltage levels of each of the pulse signals into a gate-on voltage level and a gate-off voltage level to output a plurality of gate pulse signals; and an output buffer which buffers the gate pulse signals to output the gate signals.

An exemplary embodiment of a method of driving a display device including a plurality of gate lines divided into a plurality of groups includes: receiving a plurality of tuning signals having a voltage level corresponding to a voltage of a first level or a voltage of a second level from a timing setter of the display device through a plurality of connection pads of the timing setter; generating timing information based on the tuning signals; and generating a plurality of gate signals using a gate control signal, which is generated from a signal controller of the display device based on an input video signal and an input control signal, and timing information.

In an exemplary embodiment, the method may further include generating a scan start reference signal, which instructs a scan start based on the input control signal, and a clock control reference signal, which controls each pulse width of the gate signals, as the gate control signal.

In an exemplary embodiment, the generating the gate signals may include: converting the tuning signals into digital bits corresponding to the voltage of the first level or the voltage of the second level to generate the timing information; generating a delay time corresponding to the timing information as timing data; generating a plurality of scan start signals corresponding to the groups of the gate lines, respectively, and a plurality of clock control signals corresponding to the groups of the gate lines, respectively, by delaying the scan start reference signal and the clock control reference signal based on the timing data.

In an exemplary embodiment, the generating the scan start signals and the clock control signals may include: delaying the scan start reference signal and the clock control reference signal by the delay time to generate a first scan start signal of the scan start signals and a first clock control signal of the clock control signals, where the first scan start signal and the first clock control signal correspond to the first group of the groups of the gate lines; and delaying the scan start reference signal and the clock control reference signal by a multiple of the delay time to generate a second scan start signal of the scan start signals and a second clock control signal of the clock control signals, where the second scan start signal and the second clock control signal correspond to a second group of the groups of the gate lines.

In an exemplary embodiment, the first scan start signal, the second scan start signal, the first clock control signal and the second clock control signal may have substantially the same pulse width as each other.

In an exemplary embodiment, the generating of the scan start signals and the clock control signals may include: delaying the scan start reference signal by the delay time to generate a first scan start signal of the scan start signals; delaying the clock control reference signal by the delay time to generate a first clock control signal of the clock control signals, which corresponds to the first group of the groups of the gate lines; and delaying the clock control reference signal by the multiple of the delay time to generate a second clock control signal of the clock control signals, which corresponds to the second group of the groups of the gate lines.

In an exemplary embodiment, the first scan start signal may have a pulse width overlapping rising edges of the first clock control signal and the second clock control signal.

In an exemplary embodiment, the method may further include: generating a plurality of pulse signals corresponding to the plurality of groups, respectively, in synchronization with a rising edge of a corresponding clock control signal of the clock control signals during an activation period of a corresponding scan start signal of the scan start signals; converting voltage levels of each of the pulse signals into a gate-on voltage or a gate-off voltage level to output a plurality of gate pulse signals; and buffering the gate pulse signals to output the gate signals.

In exemplary embodiments of the display device the number of signal wires connected to the gate driving IC is substantially reduced, and timing information is provided to the gate driving IC using the external connection pad, thereby realizing a slim bezel and effectively preventing the coupling capacitance between the wires.

In such embodiments, the operation timing of the gate driving IC may be controlled through the external connection pad after the gate driving IC is mounted to the circuit board.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram showing an exemplary embodiment of a display device according to the invention;

FIG. 2 is a block diagram showing an exemplary embodiment of a gate driver 300 shown in FIG. 1;

FIG. 3 is a block diagram showing an exemplary embodiment of a timing controller 330 shown in FIG. 2;

FIG. 4 is a block diagram showing an exemplary embodiment of a shift register 340 and the level shifter 350 shown in FIG. 2;

FIG. 5 is a block diagram showing an alternative exemplary embodiment of the timing controller 330′ according to the invention;

FIG. 6 is a block diagram showing an exemplary embodiment of an address pointing register 320′ according to the invention;

FIG. 7 is a block diagram showing an alternative exemplary embodiment of an address pointing register 320″ according to the invention;

FIG. 8 and FIG. 9 are schematic views showing an input wire of a gate driver 300 of a comparative embodiment and an exemplary embodiment of the invention, respectively; and

FIG. 10 and FIG. 11 are schematic views showing waveforms of an output signal of a gate driver in a comparative embodiment and an exemplary embodiment of the invention, respectively.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

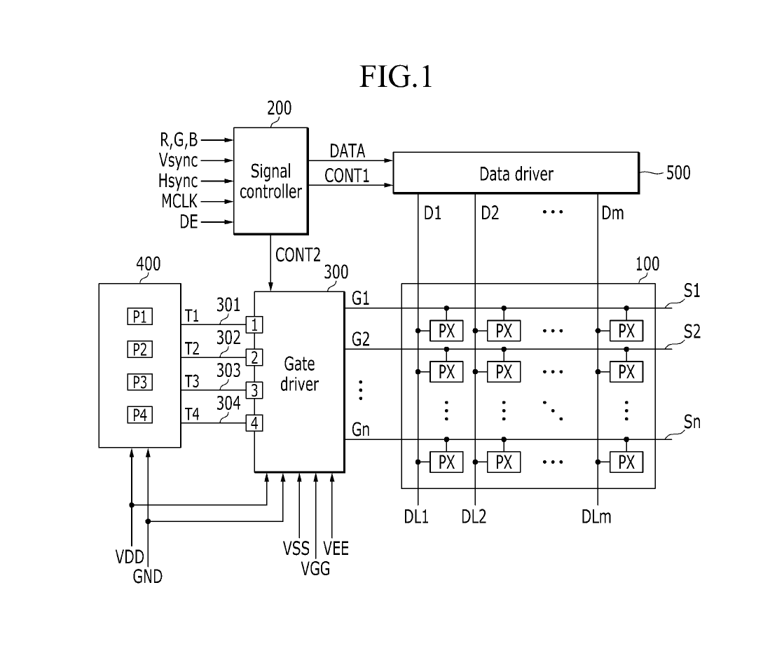

FIG. 1 is a block diagram showing an exemplary embodiment of a display device according to the invention.

Referring to FIG. 1, an exemplary embodiment of a display device includes a display panel 100, a signal controller 200, a gate driver 300, a timing setter 400 and a data driver 500. In an exemplary embodiment, the signal controller 200, the gate driver 300 and the data driver 500 may be integrated in a single chip. In an alternative exemplary embodiment, the signal controller 200, the gate driver 300 and the data driver 500 may be attached to the display panel 100 in the form of a tape carrier package (“TCP”) on a flexible printed circuit (“FPC”). In another alternative exemplary embodiment, the signal controller 200, the gate driver 300 and the data driver 500 may be attached on a separate flexible printed circuit (“FPC”) (or a printed circuit board). In such an embodiment, the display panel 100 may be one of a liquid crystal display panel and an organic light emitting display panel, for example.

In an exemplary embodiment, the display panel 100 includes a plurality of gate lines, e.g., first to n-th gate lines S1-Sn, that transmits a plurality of gate signals, e.g., first to n-th gate signals G1-Gn, a plurality of data lines, e.g., first to m-th data lines DL1-DLm, that transmits a plurality of data signals, e.g., first to m-th data signals D1-Dm, and a plurality of pixels PX connected to the gate lines S1-Sn and the data lines D1-Dm. In such an embodiment, each pixel PX may be connected to a corresponding gate line of the gate lines S1-Sn and a corresponding data line of the data lines D1-Dm. Here, each of n and m is a natural number.

The signal controller 200 receives input video signals R, G and B and input control signals that controls a display of the input video signals R, G and B, for example, a vertical synchronization signal Vsync, a horizontal synchronization signal Hsync, a main clock signal MCLK and a data enable signal DE. The signal controller 200 generates image data DATA and a data control signal CONT1 based on the input video signals R, G and B, and the input control signals, and transmits the image data DATA to the data driver 500 along with the data control signal CONT1.

In an exemplary embodiment, the signal controller 200 generates a gate control signal CONT2 based on the input control signal, and transmits the gate control signal CONT2 to the gate driver 300. In such an embodiment, the gate control signal CONT2 may include a scan start reference signal STVS that instructs a scan start, and a clock control reference signal CPVS that controls each pulse width of the gate signals G1-Gn. Each of the scan start reference signal STVS and the clock control reference signal CPVS include a pulse signal that is activated during a frame unit.

In an exemplary embodiment, the gate driver 300 includes a plurality of input pins, e.g., first to fourth pins 1-4, and receives a plurality of predetermined tuning signals, e.g., first to fourth tuning signals T1-T4, from the timing setter 400 through the input pins 1-4. In an exemplary embodiment, the gate driver 300 may further receive a first power source voltage VDD, a second power source voltage VSS, a ground voltage GND, a gate on voltage VGG and a gate off voltage VEE, for example.

The gate driver 300 generates timing information corresponding to the tuning signals T1-T4, and generates the gate signals G1-Gn using the gate control signal CONT2 and the timing information. In an exemplary embodiment, the gate driver 300 divides the gate lines S1-Sn into four groups, and the four groups of the gate lines S1-Sn are driven independently of each other by the gate driver 300. Hereafter, (4 k+1)-th gate lines of the gate lines S1-Sn are defined as a first group, (4 k+2)-th gate lines of the gate lines S1-Sn are defined as a second group, (4 k+3)-th gate lines are defined as a third group, and (4 k+4)-th gate lines are defined as fourth group. Here, k is an integer equal to or greater than zero (0).

The timing setter 400 includes a plurality of connection pads, e.g., first to fourth connection pads P1-P4, and each of the connection pads P1-P4 may be connected to a voltage of a first level (e.g., the first power source voltage VDD) or a voltage of second level (e.g., first level the ground voltage GND). The connection pads P1-P4 are connected to the gate driver 300 through a plurality of wires, e.g., first to fourth wires 301-304.

In an exemplary embodiment, the connection pads P1-P4 is disposed on a circuit board disposed outside the gate driver 300. In such an embodiment, a connection between the connection pads P1-P4 and the first power source voltage VDD or the ground voltage GND is determined by a user, and the connection pads P1-P4 and the first power source voltage VDD or the ground voltage GND may be connected after the gate driver 300 is attached to the circuit board.

In an exemplary embodiment, the tuning signals T1-T4 transmitted to the gate driver 300 through the wires 301-304 are determined based on the connection between the connection pads P1-P4 and the first power source voltage VDD or the ground voltage GND.

The data driver 500 converts the image data DATA into the data signals D1-Dm based on the data control signal CONT1, and transmits the data signals D1-Dm to the data lines DL1-DLm, respectively.

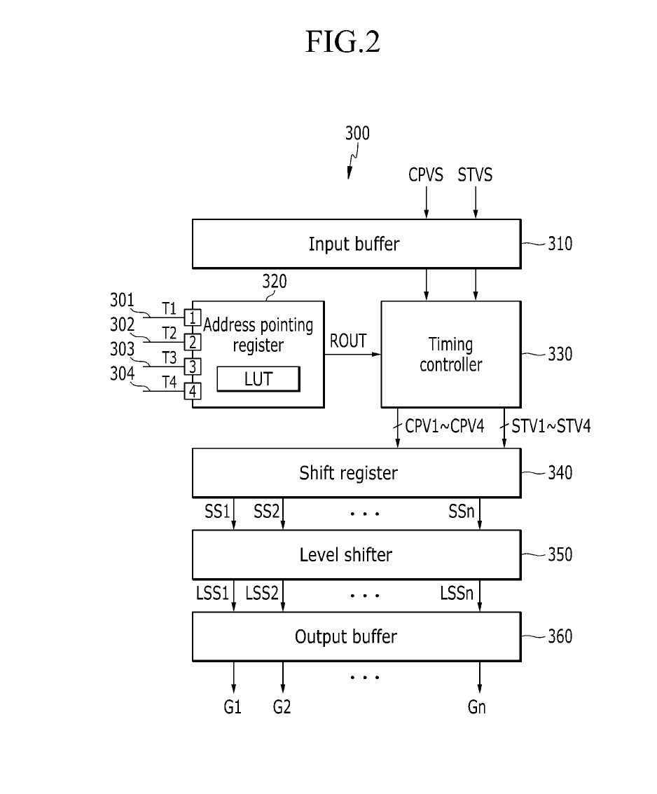

FIG. 2 is a block diagram showing an exemplary embodiment of the gate driver 300 shown in FIG. 1.

Referring to FIG. 2, an exemplary embodiment of the gate driver 300 according to the invention includes an input buffer 310, an address pointing register 320, a timing controller 330, a shift register 340, a level shifter 350 and an output buffer 360. In such an embodiment, the input buffer 310 may receive the scan start reference signal STVS and the clock control reference signal CPVS for buffering, and transmits the scan start reference signal STVS and the clock control reference signal CPVS to the timing controller 330.

In an exemplary embodiment, the address pointing register 320 includes the first to fourth input pins 1-4 connected to the wires 301-304, respectively. The address pointing register 320 receives the tuning signals T1-T4 corresponding to the first power source voltage VDD or the ground voltage GND through the first to fourth input pins 1-4.

In an exemplary embodiment, the address pointing register 320 generates the timing information by performing digital signal processing on the tuning signals T1-T4. In such an embodiment, the address pointing register 320 converts a tuning signal corresponding to the first power source voltage VDD into a ‘1’ digital bit, and converts a tuning signal corresponding to the ground voltage GND into a ‘0’ digital bit to generate the timing information of 4 bit data.

In one exemplary embodiment, for example, where the first and second connection pads P1 and P2 are connected to the first power source voltage VDD, and the third and fourth connection pads P3 and P4 are connected to the ground voltage GND, the address pointing register 320 generates the timing information as ‘1100’.

In an exemplary embodiment, the address pointing register 320 includes a lookup table LUT, which stores a delay time for the timing information. In such an embodiment, the lookup table LUT may include a first reference delay time corresponding to the scan start reference signal STVS and a second reference delay time corresponding to the clock control reference signal CPVS for each timing information set. The address pointing register 320 extracts the delay time corresponding to the generated timing information from the lookup table LUT to generate timing data ROUT.

The timing controller 330 selectively delays the scan start reference signal STVS and the clock control reference signal CPVS output from the input buffer 310 based on the timing data ROUT to generate first to fourth scan start signals STV1-STV4 and first to fourth clock control signals CPV1-CPV4, which correspond to the first to fourth groups of the gate lines S1-Sn, respectively.

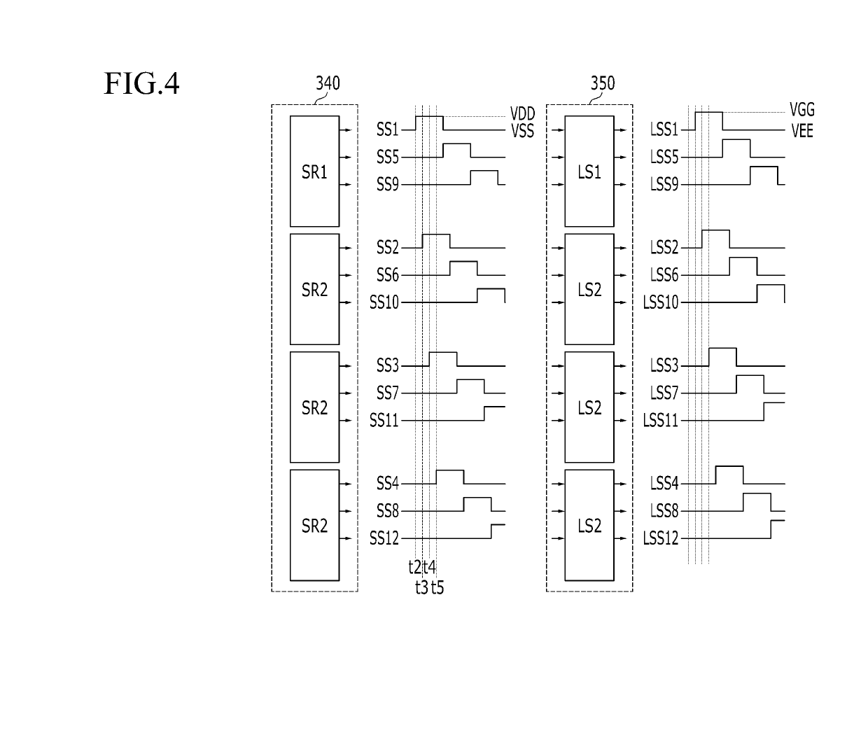

In an exemplary embodiment, the shift register 340 outputs a plurality of pulse signals, e.g., first to n-th pulse signals SS1-SSn, based on the first to fourth scan start signals STV1-STV4 and the first to fourth clock control signals CPV1-CPV4. In such an embodiment, a high level of the pulse signals SS1-SSn corresponds to the first power source voltage VDD (shown in FIG. 4) and a low level of the pulse signals SS1-SSn corresponds to the second power source voltage VSS (shown in FIG. 4). The level shifter 350 converts a voltage level of the pulse signals SS1-SSn into the gate-on voltage VGG (shown in FIG. 4) and the gate-off voltage VEE (shown in FIG. 4) to output a plurality of gate pulse signals, e.g., first to n-th gate pulse signals LSS1-LSSn. The output buffer 360 buffers the gate pulse signals LSS1-LSSn to output the gate signals G1-Gn.

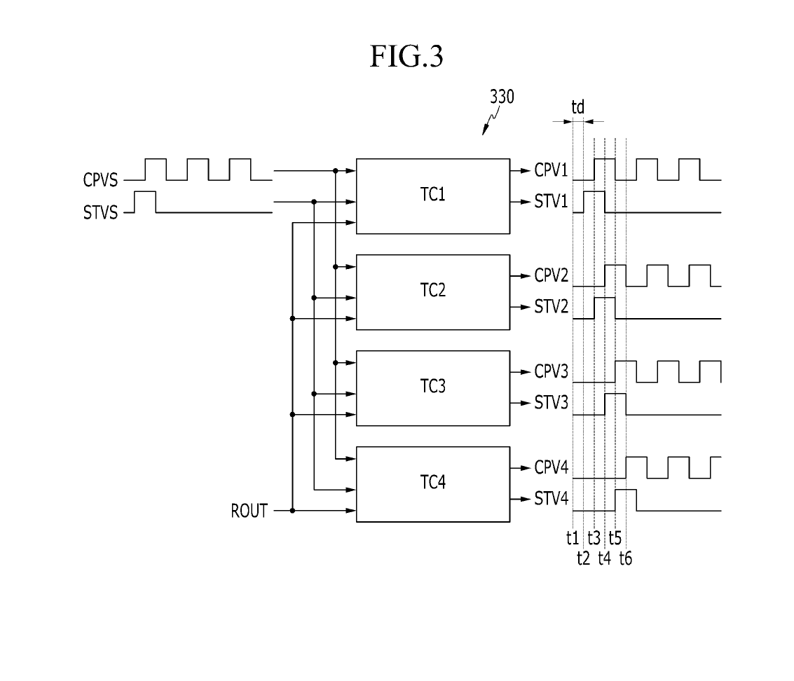

FIG. 3 is a block diagram showing an exemplary embodiment of the timing controller 330 shown in FIG. 2.

Referring to FIG. 3, an exemplary embodiment of the timing controller 330 according to the invention includes first to fourth sub-timing controllers TC1-TC4 corresponding to the first to fourth groups of the gate lines S1-Sn, respectively.

In an exemplary embodiment, each of the first to fourth sub-timing controllers TC1-TC4 receive the scan start reference signal STVS, the clock control reference signal CPVS and the timing data ROUT. Hereinafter, an exemplary embodiment where the timing data ROUT is the delay time corresponding to a unit time td will be described for convenience of description.

The first sub-timing controller TC1 delays each of the scan start reference signal STVS and the clock control reference signal CPVS by the unit time td to generate the first scan start signal STV1 and the first clock control signal CPV1.

In such an embodiment, the first scan start signal STV1 is activated at a second time point t2, and the first clock control signal CPV1 is activated at a third time point t3. In such an embodiment, the first sub-timing controller TC1 generates the first scan start signal STV1 and the first clock control signal CPV1 to have a same pulse width, e.g., a pulse width corresponding to two times the unit time td, as shown in FIG. 3.

In such an embodiment, the second sub-timing controller TC2 delays each of the scan start reference signal STVS and the clock control reference signal CPVS by two times the unit time td to generate the second scan start signal STV2 and the second clock control signal CPV2. In such an embodiment, the second scan start signal STV2 is activated at the third time point t3, and the second clock control signal CPV2 is activated at a fourth time point t4.

In such an embodiment, the third sub-timing controller TC3 respectively delays the scan start reference signal STVS and the clock control reference signal CPVS by three times the unit time td to generate the third scan start signal STV3 and the third clock control signal CPV3. In such an embodiment, the third scan start signal STV3 is activated at the fourth time point t4, and the third clock control signal CPV3 is activated at a fifth time point t5.

In such an embodiment, the fourth sub-timing controller TC4 respectively delays the scan start reference signal STVS and the clock control reference signal CPVS by four times the unit time td to generate the fourth scan start signal STV4 and the fourth clock control signal CPV4. In such an embodiment, the fourth scan start signal STV4 is activated at the fifth time point t5, and the fourth clock control signal CPV4 is activated at a sixth time point t6.

FIG. 4 is a block diagram showing an exemplary embodiment of the shift register 340 and the level shifter 350 shown in FIG. 2.

Referring to FIG. 4, an exemplary embodiment of the shift register 340 includes the first to fourth shift registers SR1-SR4 corresponding to the first to fourth groups of the gate lines S1-Sn, respectively. In such an embodiment, the level shifter 350 includes the first to fourth level shifters LS1-LS4 corresponding to the first to fourth groups of the gate line S1-Sn, respectively. In FIG. 4, only 12 pulse signals SS1-SS12 and 12 gate pulse signals LSS1-LSS12 are shown for convenience of illustration, and the remaining pulse signals and the remaining gate pulse signals are generated in substantially the same manner as the 12 pulse signals SS1-SS12 and the 12 gate pulse signals LSS1-LSS12 shown in FIG. 4.

The first shift register SR1 is in synchronization with a rising edge of the first clock control signal CPV1 during an activation period of the first scan start signal STV1 to output the first pulse signal SS1. The first shift register SR1 sequentially shifts the first pulse signal SS1 by a predetermined time to output the fifth pulse signal SS5 and the ninth pulse signal SS9.

The second shift register SR2 is in synchronization with a rising edge of the second clock control signal CPV2 during the activation period of the second scan start signal STV2 to output the second pulse signal SS2. The second shift register SR2 sequentially shifts the second pulse signal SS2 by the predetermined time to output the sixth pulse signal SS6 and the tenth pulse signal SS10.

The third shift register SR3 is in synchronization with a rising edge of the third clock control signal CPV3 during the activation period of the third scan start signal STV3 to output the third pulse signal SS3. The third shift register SR3 sequentially shifts the third pulse signal SS3 by the predetermined time to output the seventh pulse signal SS7 and the eleventh pulse signal SS11.

The fourth shift register SR4 is in synchronization with a rising edge of the fourth clock control signal CPV4 during the activation period of the fourth scan start signal STV4 to output the fourth pulse signal SS4. The fourth shift register SR4 sequentially shifts the fourth pulse signal SS4 by the predetermined time to output the eighth pulse signal SS8 and the twelfth pulse signal SS12.

The first level shifter LS1 converts the (4 k+1)-th pulse signal output from the first shift register SR1. In an exemplary embodiment, as shown in FIG. 4, each voltage level of the first, fifth and ninth pulse signals SS1, SS5 and SS9 is converted into the level of the gate-on voltage VGG and the gate-off voltage VEE. The second level shifter LS2 converts the (4 k+2)-th pulse signal output from the second shift register SR2. In such an embodiment, each voltage level of the second, sixth, and tenth pulse signals SS2, SS6 and SS10 into the level of the gate-on voltage VGG and the gate-off voltage VEE.

In such an embodiment, the third and fourth level shifters LS3 and LS4 convert each voltage level of the (4 k+3)-th and the (4 k+4)-th pulse signal output from the third and fourth shift registers SR3 and SR4 into the level of the gate-on voltage VGG and the gate-off voltage VEE.

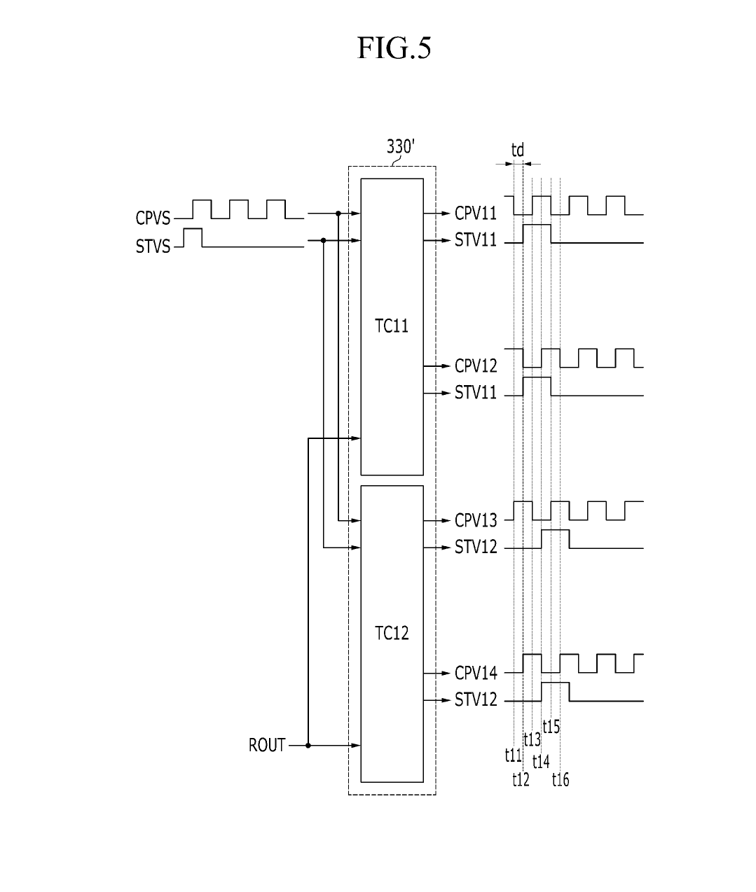

FIG. 5 is a block diagram showing an alternative exemplary embodiment of a timing controller 330′ according to the invention.

Referring to FIG. 5, an exemplary embodiment of the timing controller 330′ may include a first sub-timing controller TC11 and a second sub-timing controller TC12. In such an embodiment, the first sub-timing controller TC11 and the second sub-timing controller TC12 receive the scan start reference signal STVS, the clock control reference signal CPVS and the timing data ROUT. Hereinafter, an exemplary embodiment where the timing data ROUT is the delay time corresponding to the unit time td will be described for convenience of description.

The first sub-timing controller TC11 delays the scan start reference signal STVS by the unit time td to generate a first scan start signal STV11. The first sub-timing controller TC11 delays the clock control reference signal CPVS by the unit time td to generate a first clock control signal CPV11, and delays the clock control reference signal CPVS by two times the unit time td to generate a second clock control signal CPV12.

The first sub-timing controller TC11 transmits the first scan start signal STV11 to the first and second shift registers SR1 and SR2, the first clock control signal CPV11 to the first shift register SR1, and the second clock control signal CPV12 to the second shift register SR2. In an exemplary embodiment, as shown in FIG. 3, the first and second sub-timing controllers TC1 and TC2 may output the first and second scan start signals STV1 and STV2, respectively. In an alternative exemplary embodiment, as shown in FIG. 5, the first scan start signal STV11 is simultaneously output the first clock control signal CPV11 to the first shift register SR1 and the second shift register SR2. In an exemplary embodiment, as shown in FIG. 5, the timing controller 330′ includes two sub-timing controllers TC11 and TC12. In an alternative exemplary embodiment, the timing controller 330′ may include four sub-timing controllers TC1-TC4 as shown in FIG. 3, and two sub-timing controllers TC1 and TC2 among the four sub-timing controllers TC1-TC4 may collectively operate as the first sub-timing controller TC11 shown in FIG. 5, and remaining two sub-timing controllers TC3 and TC4 may collectively operate as the second sub-timing controller TC12 shown in FIG. 5.

In an exemplary embodiment, as shown in FIG. 5, the first sub-timing controller TC11 may generate the pulse width of the first scan start signal STV11 to be greater than the pulse width of the first scan start signal STV1 shown in FIG. 3. In such an embodiment, two shift registers SR1 and SR2 are controlled by the first scan start signal STV11, and the activation period of the first scan start signal STV11 may be controlled to overlap the rising edge of the first and second clock control signals CPV11 and CPV12. In one exemplary embodiment, for example, the first scan start signal STV11 may be generated to have a pulse width corresponding to three times the unit time td, and each of the first clock control signal CPV11 and the second clock signal CPV12 may be generated to have a pulse width corresponding to two times the unit time td.

In such an embodiment, the second sub-timing controller TC12 delays the scan start reference signal STVS by three times the unit time td to generate the second scan start signal STV12. The second sub-timing controller TC12 delays the clock control reference signal CPVS by three times the unit time td to generate the third clock control signal CPV13 and the clock control reference signal CPVS by four times the unit time td to generate the fourth clock control signal CPV14.

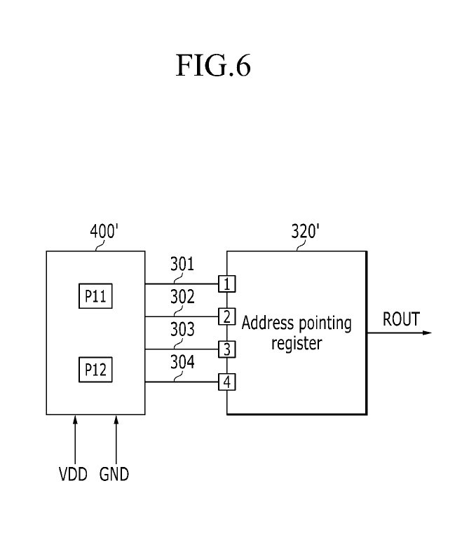

FIG. 6 is a block diagram showing an alternative exemplary embodiment of an address pointing register 320′ according to the invention.

Referring to FIG. 6, an exemplary embodiment of the address pointing register 320′ according to the invention is substantially the same as the exemplary embodiment of the address pointing register 320 shown in in FIGS. 1 and 2, except that the wires 301-304 are connected to two connection pads P11 and P12. In such an embodiment, the four input pins 1-4 may collectively correspond to the two connection pads P11 and P12. In such an embodiment, two connection pads, e.g., first and second connection pads P11 and P12, are connected to the first power source voltage VDD and the ground voltage GND, respectively, for example.

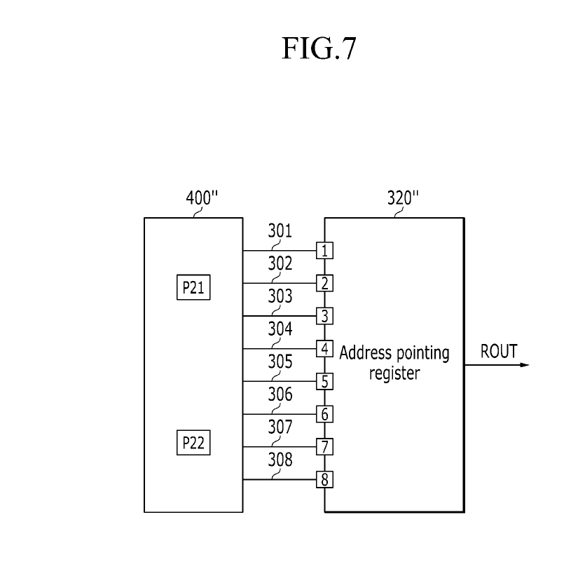

FIG. 7 is a block diagram showing another alternative exemplary embodiment of an address pointing register 320″ according to the invention.

Referring to FIG. 7, an exemplary embodiment of the address pointing register 320″ according to of the invention is connected to two connection pads P21 and P22, and includes 8 input pins 1-8. In an exemplary embodiment, where the address pointing register includes four input pins, the address pointing register may receive 16 timing information sets. In an alternative exemplary embodiment, where the address pointing register includes the 8 input pins is connected to a timing setter 400″ via first to eighth wires 301-308, as shown in FIG. 7, the address pointing register 320″ may receive 256 timing information sets.

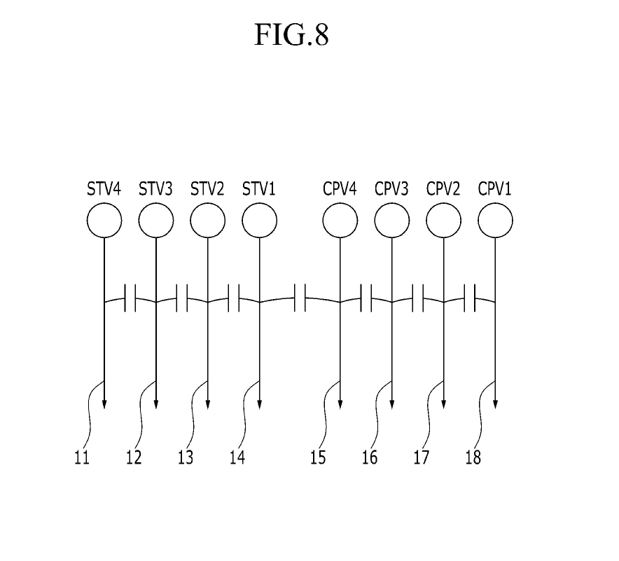

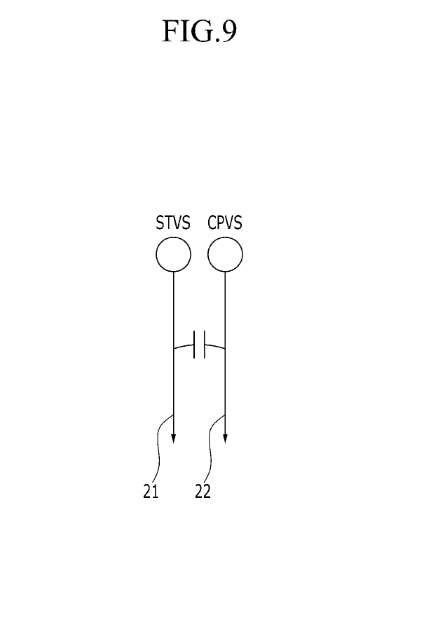

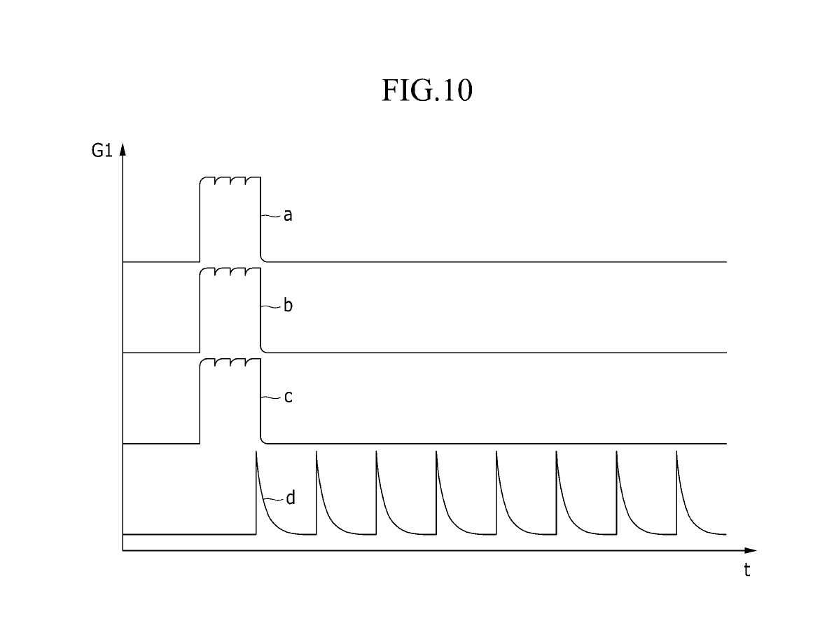

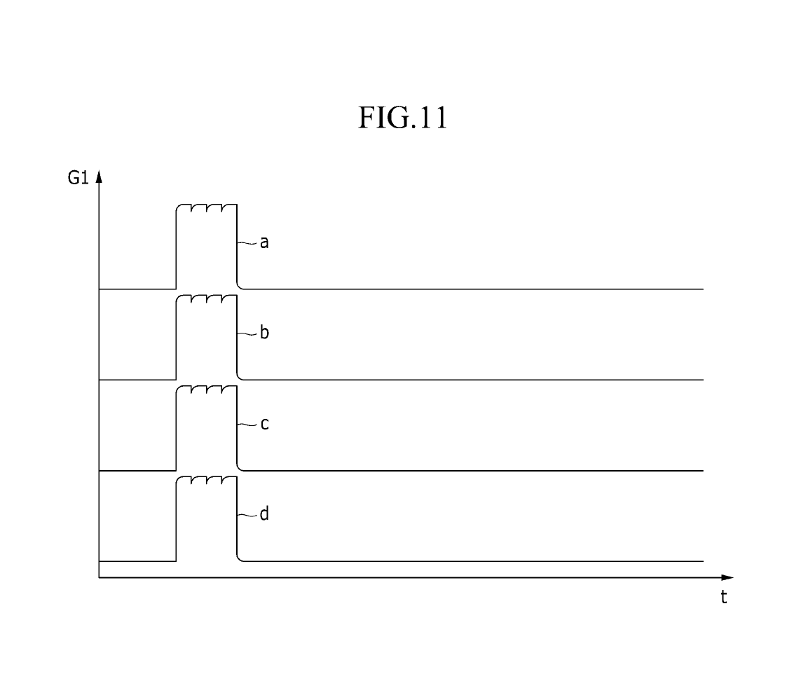

FIG. 8 and FIG. 9 are schematic views showing an input wire of a gate driver 300 of a comparative embodiment and an exemplary embodiment of the invention, respectively, and FIG. 10 and FIG. 11 are schematic views showing waveforms of an output signal of a gate driver in a comparative embodiment and an exemplary embodiment of the invention, respectively.

Referring to FIG. 8, the gate driver 300 of the comparative embodiment is connected to 8 input wires 11-18 that transmit a plurality of scan start signals, e.g., first to fourth scan start signals STV1-STV4, and a plurality of clock control signals, e.g., first to fourth clock control signals CPV1-CPV4, from the outside. The chip size of the gate driver 300 of the comparative embodiment is generally substantially limited such that the distance between the 8 input wires 11-18 may be substantially narrow, and coupling capacitance between the input wires 11-18 may occur. The coupling capacitance between the input wires 11-18 is increased as the distance between the wires is decreased. As shown in FIG. 10 illustrating a waveform of an output signal (e.g., the first gate signal G1) of the gate driver 300 including the input wires 11-18 obtained by a simulation, in which the distance between the input wires 11-18 is set to be narrower from (a) to (d), the waveform of the gate signal G1 is distorted when the distance between the input wires is narrow.

Referring to FIG. 9, an exemplary embodiment of the gate driver 300 is connected to two input wires 21 and 22 that transmit the scan start reference signal STVS and the clock control reference signal CPVS from the outside. As shown in FIG. 11 illustrating the waveform of the first gate signal G1 obtained by a simulation under the same condition of the simulation of FIG. 9, the waveform of the gate signal G1 is substantially maintained when the distance between the wires is substantially narrow.

As described above, in an exemplary embodiment of the invention, the number of the input wires may be substantially reduced such that a margin of the wire width or the distance between the input wires is obtained, and a defect caused by the coupling capacitance is thereby effectively prevented or substantially reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel comprising:
a plurality of gate lines which transmits a plurality of gate signals;
a plurality of data lines which transmits a plurality of data signals; and
a plurality of pixels connected to the gate lines and the data lines;
a signal controller which generates image data, a data control signal and a gate control signal based on an input video signal and an input control signal;
a timing setter comprising a plurality of connection pads connected to a voltage of a first level or a voltage of a second level; and
a gate driver which generates timing information based on a plurality of tuning signals transmitted from the timing setter through the connection pads, and generates the gate signals using the gate control signal and the timing information,
wherein the gate control signal comprises a scan start reference signal, which instructs a scan start, and a clock control reference signal, which controls each pulse width of the gate signal.

2. The display device of claim 1, wherein
the gate driver converts each of the tuning signals into digital bits corresponding to the voltage of the first level or the voltage of the second level to generate the timing information, and
the gate driver comprises an address pointing register which generates a delay time corresponding to the timing information as timing data.

3. The display device of claim 2, wherein
the address pointing register comprises a lookup table which stores the delay time corresponding to the timing information.

4. The display device of claim 1, wherein
the gate lines are divided in a plurality of groups, and
the gate driver controls the groups of the gate lines independently of each other based on the scan start reference signal and the clock control reference signal.

5. The display device of claim 4, wherein
the gate driver comprises a timing controller which delays the scan start reference signal and the clock control reference signal based on a delay time corresponding to the timing information to generate a plurality of scan start signals corresponding to the groups of the gate lines and a plurality of clock control signals corresponding to the groups of the gate lines.

6. The display device of claim 5, wherein
the timing controller comprises:
a first sub-timing controller corresponding to a first group of the groups of the gate lines and which delays the scan start reference signal and the clock control reference signal by the delay time to generate a first scan start signal of the scan start signals and a first clock control signal of the clock control signals; and
a second sub-timing controller corresponding to a second group of the groups of the gate lines and which delays the scan start reference signal and the clock control reference signal by a multiple of the delay time to generate a second scan start signal of the scan start signals and a second clock control signal of the clock control signals.

7. The display device of claim 6, wherein
pulse widths of the first scan start signal, the second scan start signal, the first clock control signal and the second clock control signal are substantially the same as each other.

8. The display device of claim 5, wherein
the timing controller comprises:
a sub-timing controller which delays the scan start reference signal by the delay time to generate a first scan start signal of the scan stat signals, delays the clock control reference signal by the delay time to generate a first clock control signal of the clock control signals, which corresponds to a first group of the groups of the gate lines, and delays the clock control reference signal by the multiple of the delay time to generate a second clock control signal of the clock control signals, which corresponds to a second group of the groups of the gate lines.

9. The display device of claim 8, wherein
the sub-timing controller generates the first scan start signal with a pulse width overlapping rising edges of the first clock control signal and the second clock control signal.

10. The display device of claim 5, wherein
the gate driver comprises:
a plurality of shift registers corresponding to the groups of the gate lines, respectively, and which generates a plurality of pulse signals in synchronization with a rising edge of a corresponding clock control signal of the clock control signals during an activation period of a corresponding scan start signal of the scan start signals;
a plurality of level shifters which converts voltage levels of each of the pulse signals into a gate-on voltage level and a gate-off voltage level to output a plurality of gate pulse signals; and
an output buffer which buffers the gate pulse signals to output the gate signals.

11. A method of driving a display device including a plurality of gate lines divided into a plurality of groups, the method comprising:
receiving a plurality of tuning signals having a voltage level corresponding to a voltage of a first level or a voltage of a second level from a timing setter of the display device through a plurality of connection pads of the timing setter;
generating timing information based on the tuning signals; and
generating a plurality of gate signals using a gate control signal, which is generated from a signal controller of the display device based on an input video signal and an input control signal, and timing information.

12. The method of claim 11, further comprising:
generating a scan start reference signal, which instructs a scan start based on the input control signal, and a clock control reference signal, which controls each pulse width of the gate signals, as the gate control signal.

13. The method of claim 12, wherein
the generating the gate signals comprises:
converting the tuning signals into digital bits corresponding to the voltage of the first level or the voltage of the second level to generate the timing information;
generating a delay time corresponding to the timing information as timing data;
generating a plurality of scan start signals corresponding to the groups of the gate lines, respectively, and a plurality of clock control signals corresponding to the groups of the gate lines, respectively, by delaying the scan start reference signal and the clock control reference signal based on the timing data.

14. The method of claim 13, wherein
the generating the scan start signals and the clock control signals comprises:
delaying the scan start reference signal and the clock control reference signal by the delay time to generate a first scan start signal of the scan start signals and a first clock control signal of the clock control signals, wherein the first scan start signal and the first clock control signal correspond to a first group of the groups of the gate lines; and
delaying the scan start reference signal and the clock control reference signal by a multiple of the delay time to generate a second scan start signal of the scan start signals and a second clock control signal of the clock control signals, wherein the second scan start signal and the second clock control signal correspond to a second group of the groups of the gate lines.

15. The method of claim 14, wherein
the first scan start signal, the second scan start signal, the first clock control signal and the second clock control signal have substantially the same pulse width as each other.

16. The method of claim 13, wherein
the generating the scan start signals and the clock control signals comprises:
delaying the scan start reference signal by the delay time to generate a first scan start signal of the scan start signals;
delaying the clock control reference signal by the delay time to generate a first clock control signal of the clock control signals, which corresponds to a first group of the groups of the gate lines; and
delaying the clock control reference signal by the multiple of the delay time to generate a second clock control signal of the clock control signals, which corresponds to a second group of the groups of the gate lines.

17. The method of claim 16, wherein
the first scan start signal has a pulse width overlapping rising edges of the first clock control signal and the second clock control signal.

18. The method of claim 13, further comprising:
generating a plurality of pulse signals corresponding to the plurality of groups, respectively, in synchronization with a rising edge of a corresponding clock control signal of the clock control signals during an activation period of a corresponding scan start signal of the scan start signals;
converting voltage levels of each of the pulse signals into a gate-on voltage or a gate-off voltage level to output a plurality of gate pulse signals; and buffering the gate pulse signals to output the gate signals.
